(19) United States
(12) Patent Application Publication
(10) Pub. No.: US 2022/0198194 A1
(43) Pub. Date: Jun. 23, 2022

(54) METHOD OF EVALUATING EMPATHY OF ADVERTISING VIDEO BY USING COLOR ATTRIBUTES AND APPARATUS ADOPTING THE METHOD

(71) Applicant: SANGMYUNG UNIVERSITY INDUSTRY-ACADEMY COOPERATION FOUNDATION, Seoul (KR)

(72) Inventors: Jing ZHANG, Seoul (KR); Min Cheol WHANG, Goyang-si (KR)

(73) Assignee: SANGMYUNG UNIVERSITY INDUSTRY-ACADEMY COOPERATION FOUNDATION, Seoul (KR)

(21) Appl. No.: 17/178,673

(22) Filed: Feb. 18, 2021

(30) Foreign Application Priority Data
Dec. 23, 2020 (KR) 10-2020-0182426

(51) Int. Cl. G06K 9/00; G06K 9/62; G06K 9/46; G10L 25/57; G10L 25/90; G10L 25/24; G10L 25/21; G10L 25/63

(52) U.S. Cl. CPC G06K 9/00718; G06K 9/6276; G06K 9/4652; G10L 25/63; G10L 25/90; G10L 25/24; G10L 25/21; G10L 25/57

(57) ABSTRACT

Provided is an empathy evaluation method and apparatus using video characteristics information. The empathy evaluation method includes establishing a video database by collecting a plurality of video clips, classifying and labeling each of the video clips by empathy, preparing training data by extracting a region of interest (ROI) video from each of the video clips and extracting physical characteristics from the ROI video, generating a video characteristics model file obtained through learning using the training data include 2 labels(empathy/non-empathy) vector that is calculated by the difference between the metric measurement size trained with respect to the video characteristics. Test video into the system can automatically judge the empathy evaluation of video.

### CROSS-REFERENCE TO RELATED APPLICATION

This application is based on and claims priority under 35 U.S.C. § 119 to Korean Patent Application No. 10-2020-0182426, filed on Dec. 23, 2020, in the Korean Intellectual Property Office, the disclosure of which is incorporated by reference herein in its entirety.

### BACKGROUND

### 1. Field

The disclosure relates to a method and apparatus for empathy evaluation by using physical image characteristics or features of a video, and more particularly, to a method of empathy evaluation contained in an advertising video by using physical characteristics of images included in the advertising video.

### 2. Description of the Related Art

Advertising videos provide information on various products to viewers through various media such as the Internet, airwaves, cables, and the like. Video advertisements provided through various media induce the interest of viewers and increase the purchasing power of products through empathy.

When designing a video, an advertising video designer creates video contents by focusing on the empathy of viewers. Whether or not viewers empathize with the video content such as video advertisements and the like, that is, judgment or evaluation of empathy or non-empathy, depends on individual subjective evaluation. For successful advertising video production, an objective and scientific approach or an evaluation method is required.

An objective and scientific approach or an evaluation method is required to produce an advertising video that is highly resonant to viewers.

### SUMMARY

Provided is a method of empathy evaluation by using physical elements of a video, which enables objective and scientific empathy evaluation by viewers on content emotion contained in an advertising video, and an apparatus for measuring the empathy.

Provided is a method of empathy evaluation with the physical elements of images in an advertisement video by extracting a region of interest in the video by using eye tracking data, and an apparatus for measuring the empathy.

Additional aspects will be set forth in part in the description which follows and, in part, will be apparent from the description, or may be learned by practice of the presented embodiments of the disclosure.

According to one or more embodiments, an empathy evaluation method using video physical elements includes

establishing a video database by collecting a plurality of video clips, and labeling each of the video clips for each emotion by subjective evaluation,

extracting a region of interest (ROI) video from each of the collected video clips as a video subject to machine learning,

extracting physical characteristics from the ROI video and storing the extracted physical characteristics as training data,

generating a model file including a weight trained through machine learning using the training data, and

judging empathy of a comparative image frame that is separately input, by applying a K-Nearest Neighbor technique using finding the 2 label(empathy/non-empathy) training vector that is calculated by the difference between the metric measurement of the image feature vector, with respect to comparative video data extracted from the comparative video.

According to one or more embodiments, in the empathy evaluation method using video characteristics, the extracting of the video subject to learning includes

presenting an advertising video to a viewer through a video display,

tracking a gaze of the viewer with respect to the video display by webcam camera, and

extracting a region of interest (ROI video of an ROI to which the gaze of the viewer directs with respect to the video display and storing images of frame by frame extracted from ROI video as subjects to machine learning having a certain size.

According to one or more embodiments, in the empathy evaluation method using image physical elements, in the extracting of the ROI video, coordinates (x, y) are extracted from the video display to which the gaze of the viewer directs, and

a certain size of an ROI region including the coordinates is selected and an ROI video corresponding to the region is continuously extracted from the advertising video.

According to one or more embodiments, in the empathy evaluation method using video characteristics, the model may be a k-NN (Nearest Neighbor) model.

According to one or more embodiments, in the empathy evaluation method using image physical elements,

the physical elements may include at least one of Gray, red, green, and blue (RGB), hue, saturation, and value (HSV), or light, a ratio of change from red to green, and a ratio of change from blue to yellow (LAB).

According to one or more embodiments, in the empathy evaluation method using image physical elements, in the preparing of the training data, sound physical elements may be extracted together with the physical characteristics of the ROI video.

According to one or more embodiments, the empathy evaluation method further includes

extracting sound physical elements together in the extracting of the physical characteristics of the ROI video,

generating a sound physical elements model file including a weight trained by using the extracted sound physical elements as training data, and

judging empathy of sound data that is separately input, by using extract spectrograms with a certain sampling rate using Mel-frequency cepstral coefficients (MFCC) the audio file of the video slip such as advertising.

According to one or more embodiments, in the empathy evaluation method using video characteristics, the sound physical elements may include at least one of pitch (frequency), volume (power), or tone (Mel-frequency cepstral coefficients (MFCC), 12 coefficient).

According to one or more embodiments, in the empathy evaluation method using video characteristics,

the tone may include at least one of a low frequency spectrum average value and standard deviation, an intermediate frequency spectrum average value, or a high frequency spectrum average value and standard deviation.

According to one or more embodiments, an empathy evaluation apparatus performing the above method include

a memory storing a model file;

a processor in which an empathy evaluation program for judging empathy of input video data that is to be compared is executed, and

a video processing apparatus receiving the input video data and transmitting a received input video data to the processor.

According to one or more embodiments, in the empathy evaluation apparatus using video characteristics,

a video capture apparatus that captures halfway a video from a video source may be connected to the video processing apparatus.

According to one or more embodiments, in the empathy evaluation apparatus using video characteristics, the model file may adopt a k-NN model.

According to one or more embodiments, in the empathy evaluation apparatus using video characteristics,

the image physical elements may include at least one of Gray, red, green, and blue (RGB), hue, saturation, and value (HSV), or light, a ratio of change from red to green, and a ratio of change from blue to yellow (LAB).

According to one or more embodiments, in an empathy evaluation system using image physical elements and sound physical elements are included in the training data with the physical characteristics of the ROI video, and a model file obtained through learning using the training data may include 2 labels (empathy/non-empathy) vector that is calculated by the difference between the metric measurement size trained with respect to the video characteristics.

According to one or more embodiments, in the empathy evaluation method using video characteristics, the sound physical elements may include at least one of pitch (frequency), volume (power), or tone (Mel-frequency cepstral coefficients (MFCC), 12 coefficient).

According to one or more embodiments, in the empathy evaluation apparatus using video characteristics, the sound physical elements may include at least one of pitch (frequency), volume (power), or tone (Mel-frequency cepstral coefficients (MFCC), 12 coefficient).

According to one or more embodiments, in the empathy evaluation apparatus using video characteristics, the tone may include at least one of a low frequency spectrum average value and standard deviation, an intermediate frequency spectrum average value, or a high frequency spectrum average value and standard deviation.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a process of forming a video characteristics based empathy evaluation model according to one or more embodiments;

FIG. 2 illustrates an empathetic video database(DB) establishment process in a process of forming a video characteristics based empathy evaluation model according to one or more embodiments;

FIG. 3 illustrates an interest area video DB establishment process by using an eye tracking data in a process of forming a video characteristics based empathy evaluation model according to one or more embodiments;

FIG. 4A illustrates a process of extracting physical characteristics per video in a process of forming a video characteristics based empathy evaluation model according to one or more embodiments;

FIG. 4B illustrates a sound characteristics extraction process in a process of forming a video characteristics based empathy evaluation model according to one or more embodiments;

FIG. 5 illustrates an empathy association characteristics extraction process in a process of forming a video characteristics based empathy evaluation model according to one or more embodiments;

FIG. 6 illustrates a learning and validation process for empathy prediction in a process of forming a video characteristics based empathy evaluation model according to one or more embodiments;

FIG. 7 illustrates a process of extracting a video characteristics from a region of interest of the entire video in a process of forming based empathy evaluation model according to one or more embodiments;

FIG. 8A illustrates video clips collected according to one or more embodiments and ROI video extracted therefrom;

FIG. 8B illustrates images of ROI videos from video clips collected according to one or more embodiments;

FIG. 9 illustrates subjective evaluation average value results regarding empathy score to 12 empathetic video stimuli according to one or more embodiments;

FIG. 10 illustrates subjective evaluation average value results regarding empathy score to 12 non-empathetic video stimuli for a video characteristics based empathy evaluation according to one or more embodiments;

FIG. 11 illustrates a correlation index of image variables for a video characteristics based empathy evaluation according to one or more embodiments;

FIG. 12 illustrates an average value and a standard deviation with respect to two groups of non-empathetic and empathetic advertisements of significant image variables for a video characteristics based empathy evaluation model according to one or more embodiments;

FIG. 13 illustrates a comparison of an average and a standard deviation with respect to non-empathy and empathy as a T-test analysis result regarding a video characteristics of grey;

FIG. 14 illustrates a comparison of a difference of two averages of non-empathy and empathy and a standard deviation as a T-test analysis result regarding a video characteristics of hue;

FIG. 15 illustrates a comparison of a difference of two averages of non-empathy and empathy and a standard deviation as a T-test analysis result regarding a video characteristics of saturation;

FIG. 16 illustrates a comparison of a difference of two averages of non-empathy and empathy and a standard deviation as a T-test analysis result regarding a video characteristics of alpha;

FIG. 17 illustrates a comparison of a difference of two averages of non-empathy and empathy and a standard deviation as a T-test analysis result regarding a video characteristics of beta;

FIG. 18 illustrates a comparison of a difference of two averages of non-empathy and empathy and a standard deviation as a T-test analysis result regarding a sound volume characteristics of low frequency spectrum average value;

FIG. 19 illustrates a comparison of a difference of two averages of non-empathy and empathy and a standard deviation as a T-test analysis result regarding a sound volume characteristics of low frequency spectrum standard deviation;

FIG. 20 illustrates a comparison of a difference of two averages of non-empathy and empathy and a standard deviation as a T-test analysis result regarding a sound volume characteristics of mid-frequency spectrum average value;

FIG. 21 illustrates a comparison of a difference of two averages of non-empathy and empathy and a standard deviation as a T-test analysis result regarding a volume characteristics of high frequency spectrum average value;

FIG. 22 illustrates a comparison of a difference of two averages of non-empathy and empathy and a standard deviation as a T-test analysis result regarding a volume characteristics of high frequency spectrum standard deviation; and

FIG. 23 is a schematic block diagram of an emotion evaluation system adopting the video characteristics based empathy evaluation model according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure will now be described more fully with reference to the accompanying drawings, in which embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art. Like reference numerals in the drawings denote like elements. Furthermore, various elements and areas are schematically illustrated in the drawings. Accordingly, the concept of the disclosure is not limited by relatively sizes or intervals illustrated in the accompanying drawings.

While such terms as “first,” “second,” etc., may be used to describe various components, such components must not be limited to the above terms. The above terms are used only to distinguish one component from another. For example, without departing from the right scope of the disclosure, a first constituent element may be referred to as a second constituent element, and vice versa.

Terms used in the specification are used for explaining a specific embodiment, not for limiting the disclosure. Thus, an expression used in a singular form in the specification also includes the expression in its plural form unless clearly specified otherwise in context. Also, terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art to which the disclosure may pertain. The terms as those defined generally used dictionaries are construed to have meanings matching that in the context of related technology and, unless clearly defined otherwise, are not construed to be ideally or excessively formal.

When a certain embodiment may be implemented differently, a specific process order may be performed differently from the described order. For example, two consecutively described processes may be performed substantially at the same time or performed in an order opposite to the described order.

A method and apparatus for evaluating empathy contained in a video by using the physical characteristics of the video according to one or more embodiments is described below in detail.

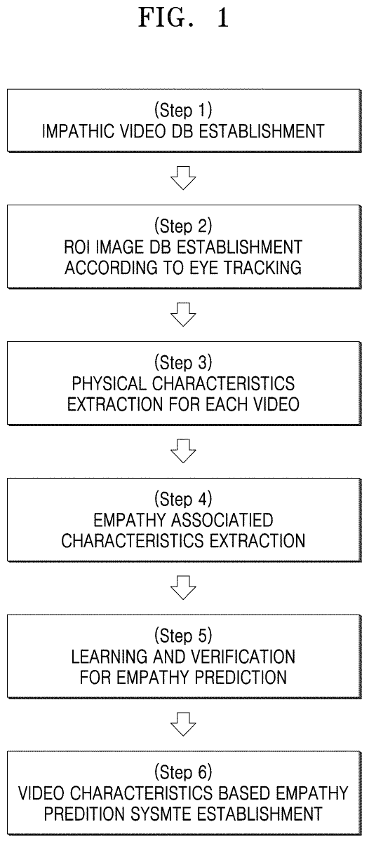

The method according to an embodiment may include the following five steps as illustrated in FIG. 1, and an apparatus performing the method is provided with hardware and software to execute the method.

Step 1: Video Clip Collection

In this process, as a step to collect various video clips for machine learning, various advertising videos are collected through various paths, and a video clip database is established using the collected video clips. In this process, subjective judgment by multiple viewers for each advertising video, and labeling for each specific emotion of empathy, non-empathy, and the like, are performed.

A system for forming the video clip database may include a display capable of displaying a video, a computer-based video reproduction apparatus capable of reproducing a video, and an input device capable of inputting the user's subjective evaluation of a video clip displayed on the display and reflecting the evaluation in the data base.

Step 2: ROI Video DB Establishment p In the video clip displayed on the display, the region of interest (ROI) is recognized in the video clip through eye or gaze tracking of a viewer looking at the display, images of frame by frame corresponding to the ROI are continuously extracted, and an ROI video database (DB) for extracting training data for machine learning is established by using the images.

Step 3: Empathy Factor Association Characteristics Extraction

In this process, the image characteristics of each of the images are analyzed, and sound characteristics are also analyzed according to the embodiment to derive and store the characteristics associated with an empathy factor as training data. The sound characteristics are optional elements, thereby enabling enhanced empathy judgment.

Step 4: Learning and Recognition Accuracy Verification for Empathy Prediction

In this process, an empathy evaluation model file (training model) is generated by performing training on the training data using a k-NN (Nearest Neighbor) technique. The model file is trained for empathy evaluation through machine learning. The accuracy of a machine learning result may be evaluated by comparing the result estimated by the training model with a subjective evaluation result.

Step 5: Video Empathy Inference System Application or Establishment using Trained Model

Finally, a system for empathy evaluation of video contents using a trained model (model file) is established. The system is based on a general computer system including a main body, a keyboard, a monitor, and the like, and particularly, an input device for comparative video input for an empathy judgment. Also, a video capture board capable of capturing video contents in the middle of a video provider and a display or projector may be provided.

The above five steps may be performed in detail as shown below, and accordingly an empathy factor is extracted from the physical characteristics of video contents, thereby establishing a technology capable of objective automatic content empathy recognition.

To this end, in the present experiment, among the physical characteristics of video contents, effective variables that may be empathy inducing factors were analyzed by a statistic method and empathy prediction accuracy was verified by using a machine learning technique. An actual experiment process is described below in detail step by step.

A. Empathetic Video Clip Collection

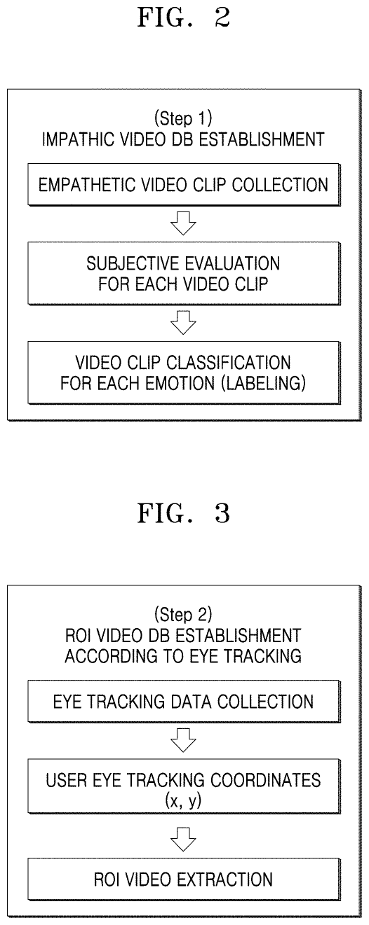

This step relates to empathy video database establishment, as illustrated in FIG. 2. In other words, various video clips including an advertising video containing specific empathy are extracted and collected from various video contents.

B. ROI Video Extraction

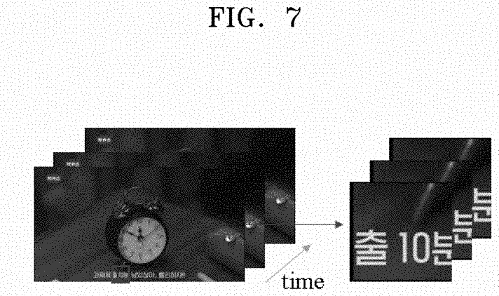

In this process, an ROI video is extracted from the collected video clip. As exemplarily illustrated in FIG. 7, a video clip is displayed on a display in units of frames (left), gaze of a viewer watching the video clip is tracked by an eye tracking method that is well-known in various forms. Gaze position coordinates (x, y) with respect to the display are detected through an eye tracking process according to a well-known eye tracking method, and an ROI having a certain size including the coordinates, as indicated by a red box in the left video in FIG. 7, is selected, and then images of frame by frame of a certain size, for example a size of 100×100 pixels, is time-serially continuously extracted from the ROI of the video clip by using the gaze position coordinates (x, y).

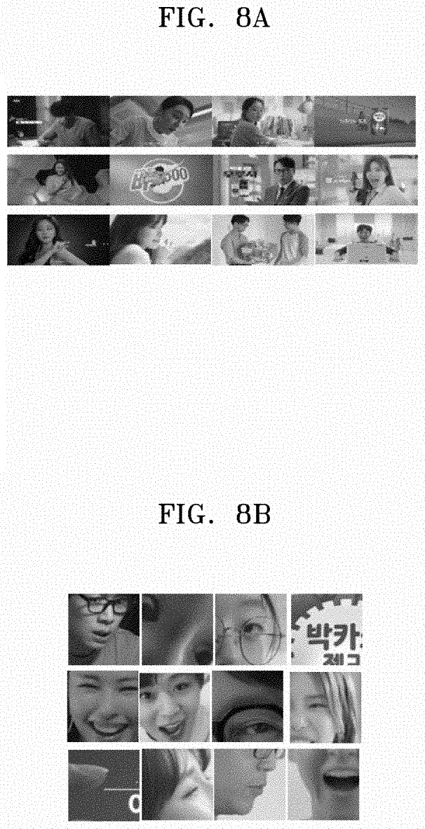

The process is performed on all collected video clips. FIG. 8A shows an example of the collected video clips, and FIG. 8B shows an example of ROI images extracted from the video clips.

This process of the ROI image extraction is performed on a video verified to express specific empathy through subjective evaluation on the video clips.

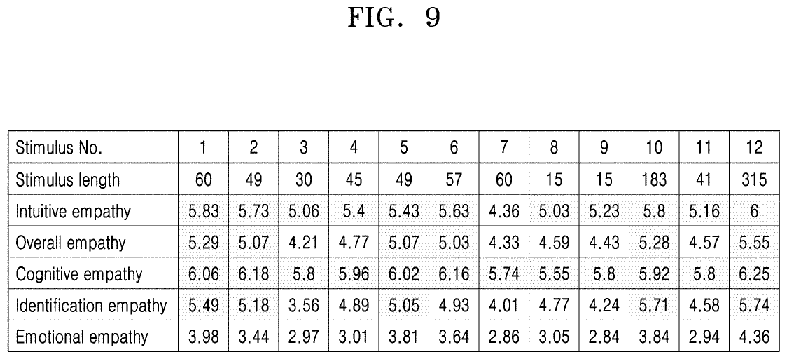

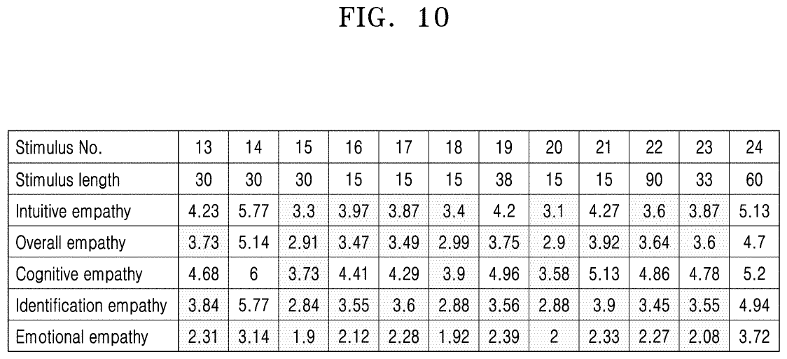

In a subjective evaluation analysis method, in the present embodiment, as illustrated in FIGS. 9 and 10, in 24 video clips (stimuli), the 1^{st} to 12^{th} stimuli are defined to be empathetic stimuli and the 13^{th} to 24^{th} stimuli are defined to be non-empathetic stimuli. A subjective evaluation scale includes 7 scales from “not very much” to “very much”.

FIGS. 9 and 10 show average values of five empathy (intuitive empathy, overall empathy, cognitive empathy, identification empathy, and emotional empathy) points based on the subjective evaluation.

C. Extraction of Physical Characteristics of a Video

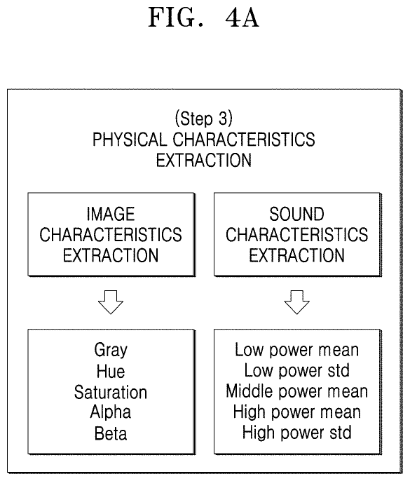

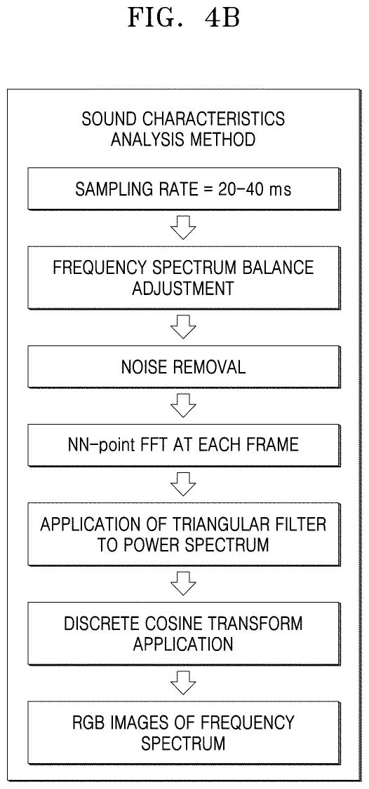

In this step, as illustrated in FIG. 4a, ten image characteristics and eighteen sound characteristics are extracted with respect to each of twelve empathetic video clips stored in the ROI video DB. The eighteen sound characteristics are optional elements, which are selected in the present embodiment. Ten image characteristics and eighteen sound characteristics among visual and acoustic physical characteristics, which are optional element, included in a video are as follows.

The image characteristics are obtained by extracting a color component included in an image based on a color model of each of Gray, red, green, and blue (RGB), hue, saturation, and value (HSV), and light, a ratio of change from red to green, and a ratio of change from blue to yellow (LAB). The sound characteristics are obtained by extracting low frequency spectrum average value and standard deviation, an intermediate frequency spectrum average value, and high frequency spectrum average value and standard deviation, and at least any one thereof is used.

Referring to FIG. 4b, a sound variable extraction process is described below in detail.

In the extraction of sound variables, it would be more effective to select a shape that fits the characteristics of the cochlea than simply using the frequency as a shape vector.

1) Sampling Step

In the first step, in an audio part (file) of a video clip such as advertisement, and the like, a spectrogram is extracted at a certain sampling rate using MFCC. For example, an output spectrum density at a dB power scale is calculated when sampling rate =20-40 ms, the width of the Hamming window is 4.15 s, a sliding size is 50 ms. An intermediate size of an intermediate size spectrum of a spectrum is 371×501 pixels.

2) Frequency Spectrum Balancing (Noise Removal).

In this step, a frequency spectrum is balanced. This step is to apply a pre-emphasizing filter to a signal to amplify a high frequency. As the intensity of a high frequency is less than the intensity of a low frequency in the pre-emphasizing filter, a frequency spectrum is balanced. A 1^{st} filter may be applied to a signal x as shown in the following equation.

y(t)=x(t)−αx(t−1)

In the present embodiment, a general value to a filter coefficient α is 0.95 or 0.97.

3) NN-Point FFT Calculation

A frequency spectrum short-time Fourier-transform (STFT) is calculated by performing a NN point FFT on each frame. NN (number of segments) is generally 256 or 512, NFFT (number of segments of FFT)=512, and a power spectrum may be calculated by using the following equation.

$$P = \frac{{\vert FFT ( {x}_{i} ) \vert}^{2}}{N}$$

xi denotes the i-th frame of an x signal, and N denotes 256.

4) Application of Triangular Filter to Power Spectrum

The final step of the filter bank calculation is extract a frequency band by applying a triangular filter (generally, 40 filters, n filter=40) to a power spectrum. The Mel scale aims to mimic the non-linear human ear perception of sound, by being more discriminative at lower frequencies and less discriminative at higher frequencies. It may be switched between hertz (f) and Mel (m) by using the following equation.

$$m = 2595 {log}_{10} ( 1 + \frac{f}{700} )$$

$$f = 700 ( {10}^{m / 2595} - 1 )$$

5) Application of Discrete Cosine Transform (DCT)

Accordingly, a discrete cosine transform (DCT) may be applied to decorate a filter bank coefficient and compressively express the filter bank.

6) Calculation of RGB Images of Frequency Spectrum

Spectrum expressions of three frequency scales allow observation of the effects of high frequency sound, mid-frequency sound, and low frequency sound characteristics, respectively. While using red (R), green (G), or blue (B) constituent element of an RGB video, the importance of sound constituent elements with high, medium, and low amplitude levels is respectively calculated.

Although the image physical elements and sound physical elements are both used as training data in the present embodiment, according to another embodiment, only one of the characteristics may be used as training data. In the following description, an embodiment in which both image physical elements and sound physical elements are commonly used is described.

D. Empathy Factor Derivation Step

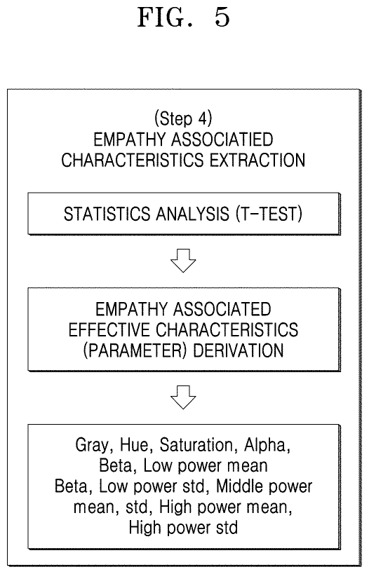

In this step, as illustrated in FIG. 5, an empathy factor is derived from the extracted physical characteristics through statistical analysis. In order to divide the characteristics based on the previously extracted eleven physical characteristics of a video into 2 labels(empathy/non-empathy), and to derive the effective characteristics that are the main factors of the empathy, T-test analysis, which is a statistical technique to analyze a difference according to two levels of empathy, is used, and then a post verification is performed.

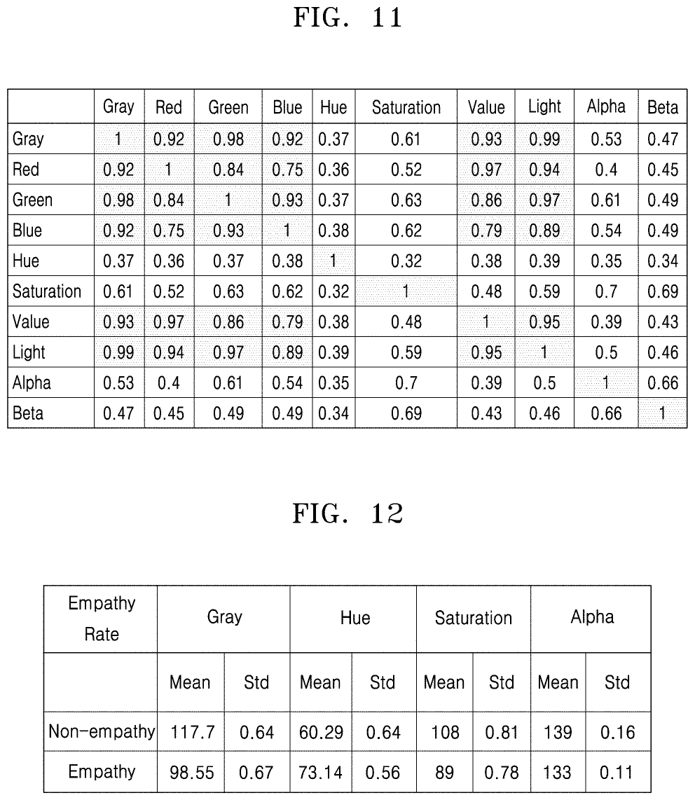

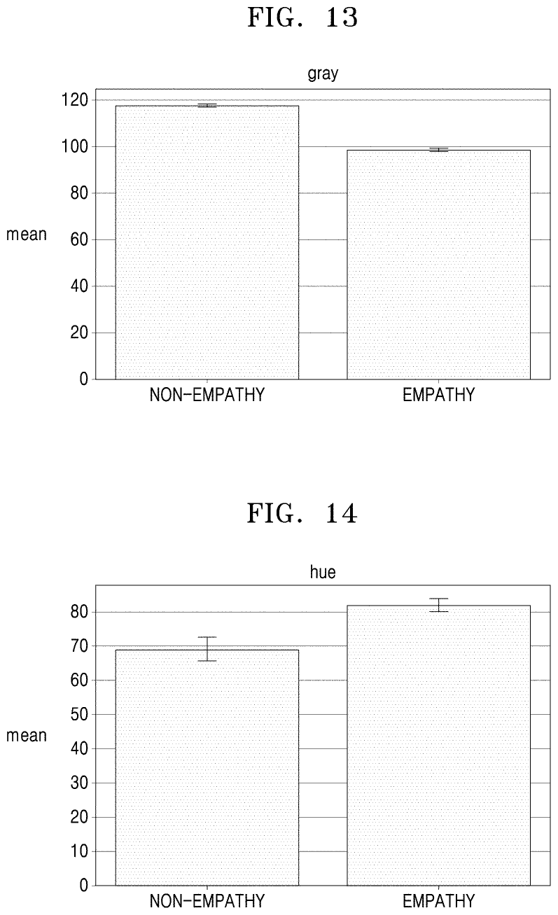

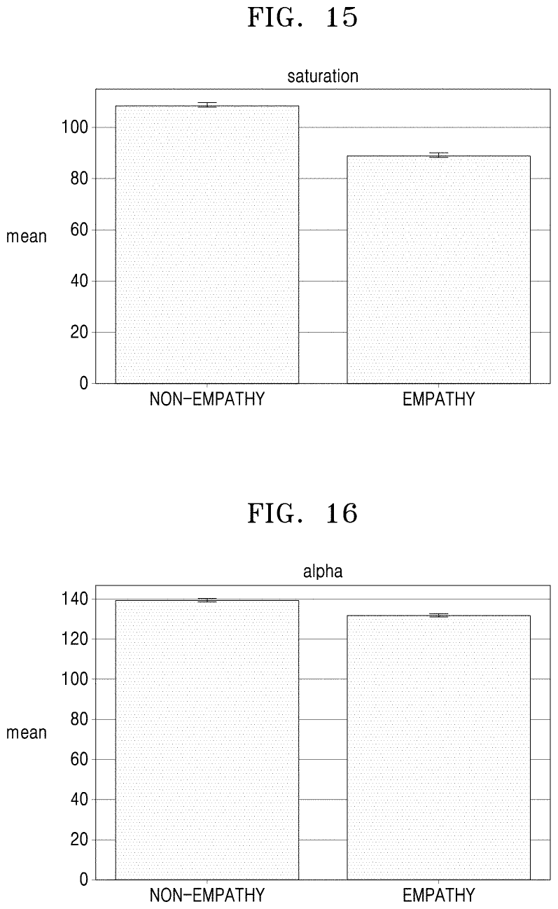

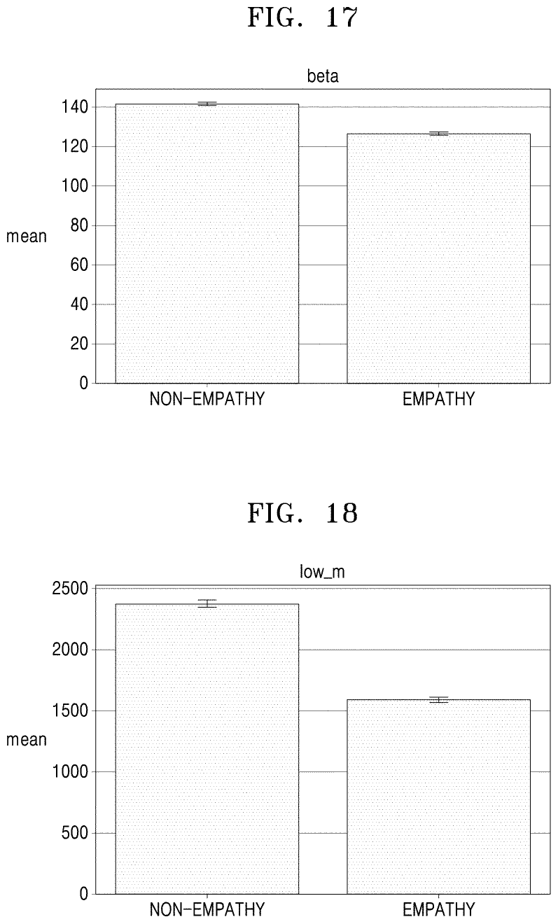

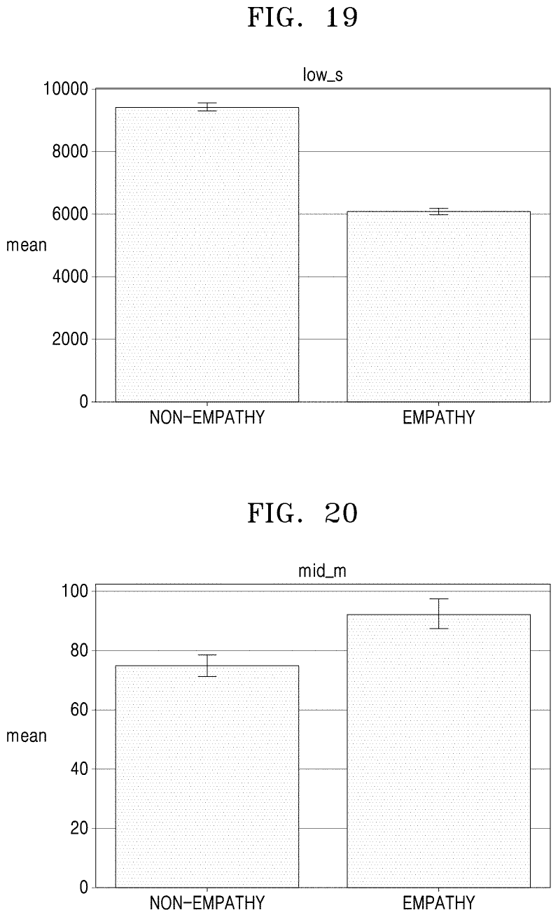

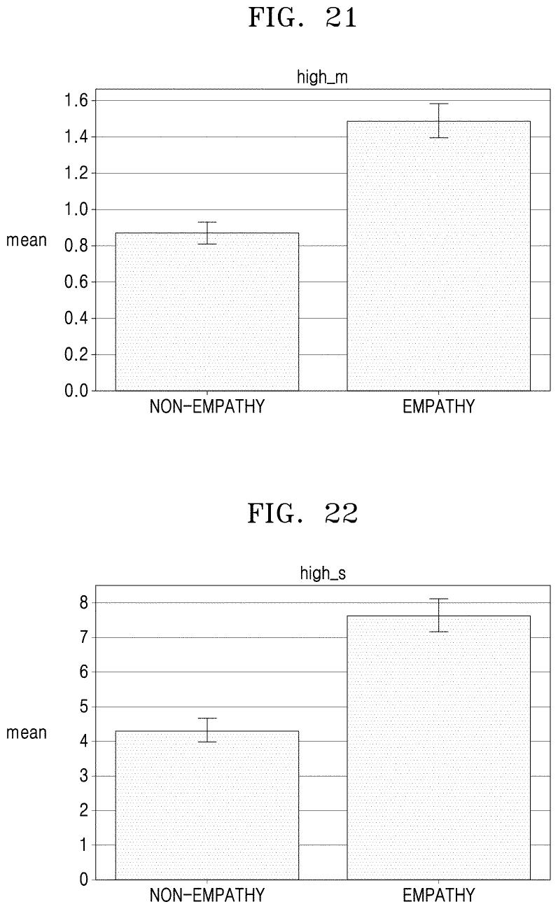

FIGS. 11 to 17 illustrate T-test analysis results of the image and sound physical elements. As the above statistical analysis result, effective parameters that have a significant difference with a significance probability (p-value) <0.001 may include gray, hue, saturation, alpha, beta, low power mean, low power, middle power mean, high power mean, and high power std.

E. Learning and Recognition Accuracy Verification for Empathy Prediction

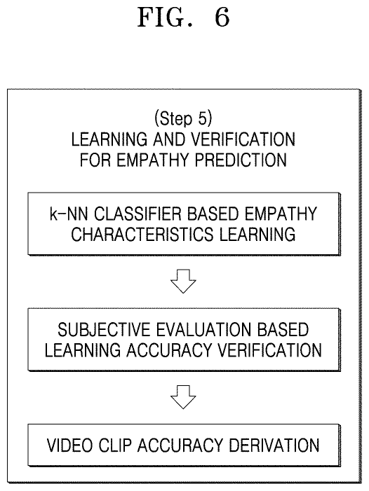

This step is, as illustrated in FIG. 6, the empathy factor characteristics data (training data) derived earlier using machine learning and the 2 labels(empathy/non-empathy) collected through a subjective questionnaire are learned by a classifier, and empathy recognition accuracy is derived as a learned result.

In the present embodiment, a K-nearest neighbor (k-NN) model was used as a classifier used for empathy learning, and accuracy obtained as a learning result is 93.66%. In the present experiment, classifiers such as the most used support vector machine (SVM), k-nearest neighbor (KNN), multi-layer perceptron (MLP), and the like were tested, and the k-NN model showed the highest accuracy through the present embodiment.

Layers of the k-NN model are as follows.

1) Input Layer

The input layer of the k-NN layer used in the present experiment may include a tensor that stores information about eleven pieces of characteristics data (raw data) and two empathy labels. The tensor may store eleven characteristics variables and has an eleven-dimensional structure.

2) Unit Problem of Distance Scale—Standardization

There are tasks that must be preceded before determining k. That is standardization.

The concept of closeness in k-NN is defined as Euclidean distance, and when calculating the Euclidean distance, a unit is very important.

The Euclidean distance between two points A and B having different coordinates (x, y) is calculated as follows.

\sqrt{(Ax−Bx)²+(Ay−By)²}

3) Finding Optimal k

The k may be identified and determined by checking what is the k that well classifies validation data based on train data.

Training of the k-NN model is performed by programming techniques on the model of the structure as described above. In this process, the concept of closeness in the k-NN is defined as Euclidean distance. When calculating the Euclidean distance, standardization is made and determine what is the k that well classifies validation data based on the train data. The trained model is generated in the form of pickle-shaped files. When training for the above model is completed, the trained k-NN model in the desired file format is obtained.

A k-NN empathy recognition model used in the present experiment is described below.

Python3 is selected as a computer language for generating a model for prediction, and a source code is explained below.

< Source Code 1 >

x, y= dataset.load_dataset( )
X_train, X_test, y_train, y_test = train_test_split(X, y test_size=0,3, random_state=0)

Source code 1 is a step to load an input data set. The store characteristics and training data are loaded as input data. X is a characteristics variable (parameter), and y is nine empathy labels. The function of python “train_test_split” was used, training data and test data are X, y automatically divided by 7:3.

< Source Code 2>

ros = RandomOverSampler(random_state=0)
class_names = [′empathy′, no_empathy′]
X_train = preprocessing.scale(X_train)
X_train, y_train = ros.fit_resample(X_train, y_train)

Source code 2 is a data set normalization step. As the collected data is asymmetric data, precision of the asymmetric data is improved when the data ratio is adjusted by using under-sampling that only partially uses data from majority classes or over-sampling that increases data from minority classes. Accordingly, RandomOverSampler is a function that adjusts a data ratio. class_name defines the name of two empathy groups.

“preprocessing.scale” in the source code 2 is a method of a “preprocessing” object that standardizes data. The method “processing.Scale” returns a value indicating how far it is away from an average. Using the method, machine learning may be improved after data standardization.

< Source Code 3>

k_range = range(1,5)
for n in k_range:
ken = KNeighborsClassifier( )
knn.fit(X_train, y_train)
print(′Train acc=′, knn.score(X_train, y_train))
print(′Test acc=′, knn.score(X_test, y_test))
print(′Estimates=′, knn.predict(X_test))
scores = cross_val_score(knn, X_train, y_train, cv=13, scoring=′accuracy′)
print(′K fold=′, scores)

Source code 3 calculates train accuracy, test accuracy, and estimates scores from 1 to 5, where k, which classifies validation data well based on the train data. A corresponding k value is found at the highest accuracy.

< Source Code 4>

report = classification_report(y_test,y_pred)
print(report)

Source code 4 evaluates model performance whether it is a good model or not, and the criteria may include accuracy, precision, recall, f1-score, and the like.

A well-trained model may be obtained through the above process, and accordingly, an empathy evaluation system using the above model as illustrated in FIG. 24 may be implemented. This system may enable empathy evaluation for each scene, either local or whole, of properly created video contents. Furthermore, for videos filmed for specific purposes, empathy evaluation may be possible, and accordingly, judgment of the empathetic atmosphere of a filming site may be possible. This video to be tested may be input to an evaluation system that adopts the model, and as described above, a video may be captured between a video source and a video display or display medium, or the video itself may be directly input to the system.

The video source may include any video source such as content providers, cameras, and the like. The evaluation system may perform evaluation of empathy for each scene unit continuously while video contents are in progress.

By applying the selected information of the input video to the trained model as above, an empathy state may be judged probabilistically. A vector having as many elements as a desired number of labels (empathy states) may be obtained through a classification function, for example, the final softmax algorithm, of a classification function layer, which processes each piece of effective information obtained from the frame of an image of the input video and the corresponding acoustic information. The maximum value of the values of the vector becomes a final prediction value that is a criterion for judgment of specific empathy, and the vector value and the label of the video, that is, the empathy state, are output.

According to the present embodiment, a model file for video characteristics extracted from a video clip is basically generated, and additionally, sound characteristics may be extracted together with video characteristics extraction from the video clip. Accordingly, a video characteristics model file and a sound characteristics model file for the image physical elements and sound physical elements may be generated together. Accordingly, in addition to the empathy judgment on the ROI of the video clip, the empathy may be judged together on the sound characteristics included in the video clip. Accordingly, when empathy is judged by the image physical elements model file and evaluated by the sound physical elements model file together, the accuracy of empathy evaluation for a sound clip may be further improved.

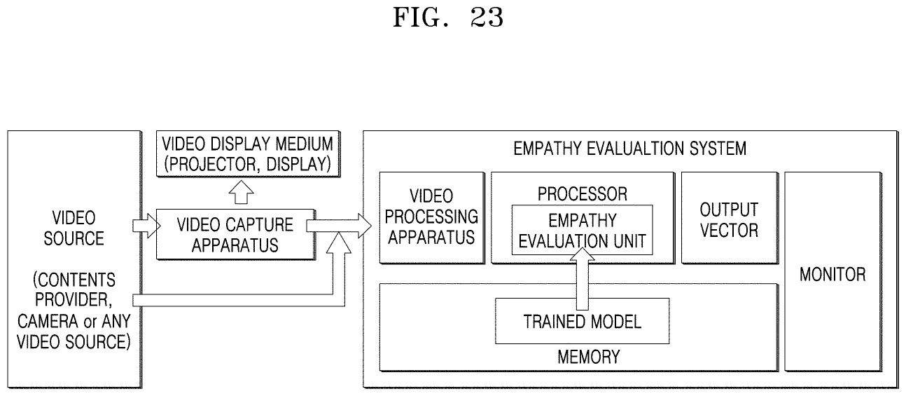

As illustrated in FIG. 23, the empathy evaluation system according to the disclosure may include a memory that stores a final model file (trained model) obtained by the method; a video processing apparatus that processes comparative video data from a video source to be judged; an empathy evaluation unit such as websites, and the like that loads or executes an empathy evaluation application or a program; a processor that forms judging empathy of a comparative image frame that is separately input, by applying a K-Nearest Neighbor technique using finding the 2 labels (empathy/non-empathy) training vector that is calculated by the difference between the metric measurement of the image feature vector, and forms an output layer (output vector) containing information of the input video by test video into the system can automatically judge the empathy evaluation of video; and a display that outputs, by the processor, empathy information of the input video.

As described above, although exemplary embodiments of the present invention are described in detail, those of ordinary skill in the art to which the present invention pertains to may variously modify the present invention and work the modifications without departing from the spirit and scope of the present invention defined in the appended claims. Accordingly, changes of embodiments of the present invention in future will not be able to depart from the technology of the present invention.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An empathy evaluation method using video characteristics, the method comprising:
establishing a video database by collecting a plurality of video clips;
classifying and labeling each of the plurality of video clips by empathy score;
preparing training data by extracting a region of interest (ROI) video from each of the plurality of video clips and extracting physical characteristics of the ROI video;
generating a video characteristics model file including a weight trained through learning using the training data; and
judging empathy of a comparative image frame that is separately input, by applying a K-Nearest Neighbor technique using finding the 2 labels (empathy/non-empathy) training vector that is calculated by the difference between the metric measurement of the image feature vector.

2. The empathy evaluation method of claim 1, wherein the video characteristics model file is a k-NN model file.

3. The empathy evaluation method of claim 2, wherein the image physical elements comprise at least one of gray, red, green, and blue (RGB), hue, saturation, and value (HSV), or light, a ratio of change from red to green, and a ratio of change from blue to yellow (LAB).

4. The empathy evaluation method of claim 1, wherein the image physical elements comprise at least one of Gray, red, green, and blue (RGB), hue, saturation, and value (HSV), or light, a ratio of change from red to green, and a ratio of change from blue to yellow (LAB).

5. The empathy evaluation method of claim 1, further comprising:
extracting sound characteristics together in the extracting of the physical characteristics of each of the plurality of video clips;
generating an acoustic characteristics model file including a weight trained by using the extracted acoustic characteristics as training data; and
judging empathy of a comparative image frame that is separately input, by applying a K-Nearest Neighbor technique using finding the 2 labels (empathy/non-empathy) training vector that is calculated by the difference between the metric measurement.

6. The empathy evaluation method of claim 5, wherein the sound characteristics comprise at least one of pitch (frequency), volume (power), or tone (Mel-frequency cepstral coefficients (MFCC), 12 coefficient).

7. The empathy evaluation method of claim 6, wherein the tone comprises at least one of a low frequency spectrum average value and standard deviation, an mid-frequency spectrum average value, or a high frequency spectrum average value and standard deviation.

8. An empathy evaluation apparatus using video characteristics, the empathy evaluation apparatus performing the method set forth in claim 1 and comprising:
a memory storing the video characteristics model file;
a processor in which an empathy evaluation software for judging empathy of input video data is executed; and
a video processing apparatus receiving the input video data and transmitting a received input video data to the processor.

9. The empathy evaluation apparatus of claim 8, wherein a video capture apparatus that captures halfway a video from an input video source is connected to the video processing apparatus.

10. The empathy evaluation apparatus of claim 8, wherein the model file is a k-NN model file.

11. The empathy evaluation apparatus of claim 8, wherein the image physical elements comprises at least one of Gray, red, green, and blue (RGB), hue, saturation, and value (HSV), or light, a ratio of change from red to green, and a ratio of change from blue to yellow (LAB).

12. The empathy evaluation apparatus of claim 8, wherein
a sound physical elements model file trained with acoustic characteristics of each of the plurality of the video clips is stored in the memory, and
the empathy evaluation unit judge empathy by applying the input video data and input acoustic data to the video characteristics model file and the sound physical elements model file, respectively.

13. The empathy evaluation apparatus of claim 12, wherein the sound physical elements comprise at least one of pitch (frequency), volume (power), or tone (Mel-frequency cepstral coefficients (MFCC), 12 coefficient).

14. The empathy evaluation apparatus of claim 13, wherein the tone comprises at least one of a low frequency spectrum average value and standard deviation, an mid-frequency spectrum average value, or a high frequency spectrum average value and standard deviation.
